(19) United States
(12) Patent Application Publication
(10) Pub. No.: US 2013/0226051 A1
(43) Pub. Date: Aug. 29, 2013

(54) Massage Bench with Sliding Backrest

(71) Applicant: Fang-yu Lu, Sinwu Township (TW)

(72) Inventor: Fang-yu Lu, Sinwu Township (TW)

(21) Appl. No.: 13/404,067

(22) Filed: Feb. 24, 2012

(51) Int. Cl. A61H 7/00

(52) U.S. Cl. 601/99

(57) ABSTRACT

A massage bench is provided with a backrest assembly mounted on a support and including two parallel arc rails secured to the support, each rail including first teeth; and a sliding unit including an arc sliding backrest having two side first gears engaging the first teeth, and a sliding foot rest slidable about the first teeth; a drive assembly including a first motor, an output shaft operatively connected to the first gears, and a drive belt placed across the first motor and the output shaft so that the backrest and the foot rest move along the rails; and a massage assembly including a back massaging assembly in the backrest and including a moveable bracket, parallel second teeth secured to the backrest, second gears on either side of the bracket engaging the second teeth, and a second motor for driving rollers and the second gears; and a legs massaging assembly.

### BACKGROUND OF THE INVENTION

1. Field of the Invention

The invention relates to massage benches and more particularly to a massage bench having a gear moveable sliding backrest.

2. Description of Related Art

Massage benches and massage chairs are widely used by people throughout the world. For example, a conventional massage bench is shown in FIGS. 7 and 8 and comprises a support 6, a plurality of rollers mounted on a curve top of the support 6, a backrest assembly 7 slidably mounted on the support 6 and including a back massage unit 71 and a leg massage unit 72, and an electric motor 8 mounted in the support 6 and being operatively connected to the rollers and the backrest assembly 7. Thus, in response to activating the motor 8 a person lying on the backrest assembly 7 can have his/her back and legs massaged by both the back massage unit 71 and the leg massage unit 72 while the backrest assembly 7 sliding back and forth on the top of the support 6.

However, a number of drawbacks have been found in the conventional massage bench. In detail, a great noise is made by the motor and a plunger associated therewith. Further, the plunger may malfunction due to leak after a period of time of use. Furthermore, the backrest assembly 7 may slip due to weight of the user, resulting in a compromise of the massage effects. In addition, the support is fixed (i.e., being not adapted to adjust) due to the configuration of the motor and the plunger.

Thus, the need for improvement still exists.

### SUMMARY OF THE INVENTION

It is therefore one object of the invention to provide a massage bench comprising a support; a backrest assembly slidably mounted on the support, the backrest assembly comprising two parallel arc rails secured to the support, each of the rails including lengthwise first teeth; and a sliding unit including an arc sliding backrest having a plurality of first gears on either side, the first gears being in gear engagement with the first teeth, and a sliding foot rest slidable about the first teeth; a drive assembly comprising a first motor, an output shaft operatively connected to the first gears, and a drive belt placed across the first motor and the output shaft wherein in response to activating the first motor power of the first motor is transmitted to the output shaft to move the first gears along the first teeth so that both the backrest and the foot rest move along the rails; and a massage assembly comprising a back massaging assembly disposed in the backrest and including a moveable bracket, parallel lengthwise second teeth secured to the backrest, a plurality of second gears disposed on either side of the bracket and being in gear engagement with the second teeth, a plurality of rollers projecting out of the bracket distal the support, and a second motor for driving both the rollers and the second gears wherein in response to activating the second motor power of the second motor is transmitted to the second gears to move the second gears along the second teeth and to the rollers; and a legs massaging assembly disposed on the foot rest, the legs massaging assembly being operatively connected to the second motor.

The above and other objects, features and advantages of the invention will become apparent from the following detailed description taken with the accompanying drawings.

### BRIEF DESCRIPTION OF THE DRAWINGS

FIG. 1 is a perspective view of a massage bench according to the invention;

FIG. 2 is another perspective view of the massage table showing details of the backrest assembly, mainly the drive assembly, by removing the rails;

FIG. 2A is a detailed view of the area in circle A of FIG. 2 showing details of the drive assembly and associated components;

FIG. 3 is another perspective view of the massage bench showing back massaging assembly;

FIG. 3A is a detailed view of the area in a dotted circle of FIG. 3;

FIG. 4 is a view similar to FIG. 1 showing a person lying on the backrest during a massage;

FIG. 5 is a side elevation of FIG. 4;

FIG. 6 is a view similar to FIG. 5 showing a sliding movement of the backrest during the massage;

FIG. 7 is a perspective view of a conventional massage bench; and

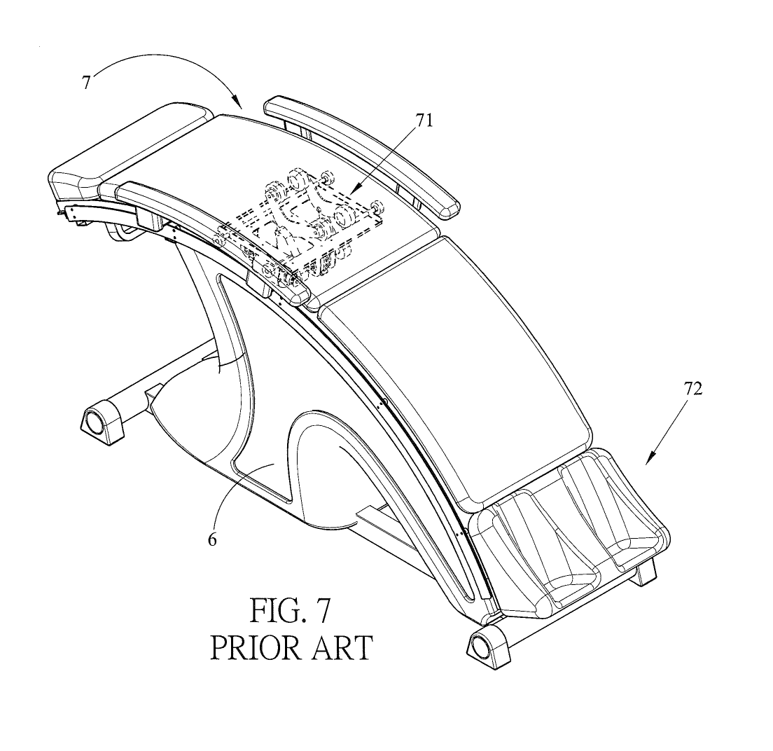

FIG. 8 is a side elevation of FIG. 7.

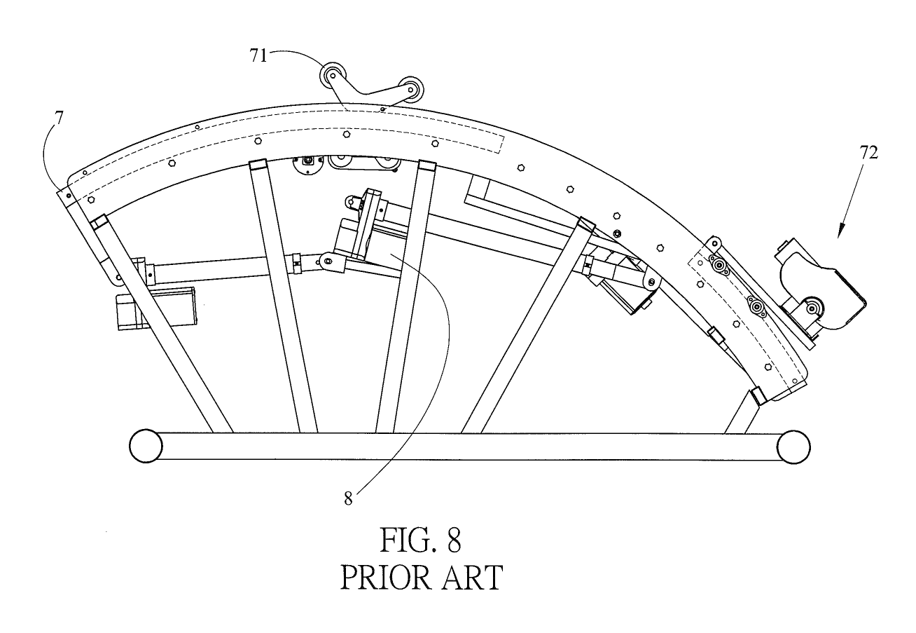

### DETAILED DESCRIPTION OF THE INVENTION

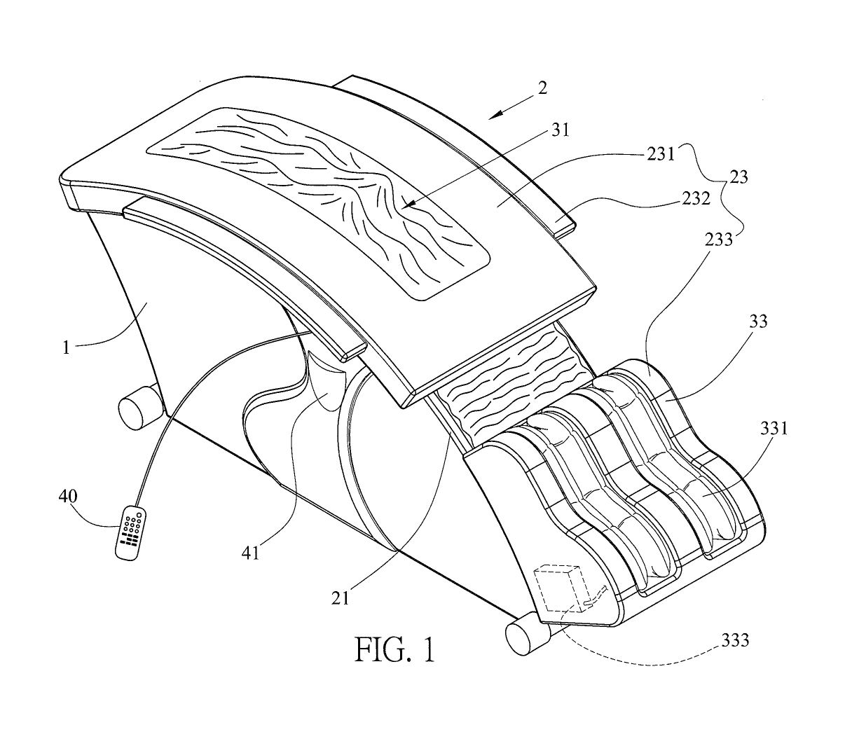

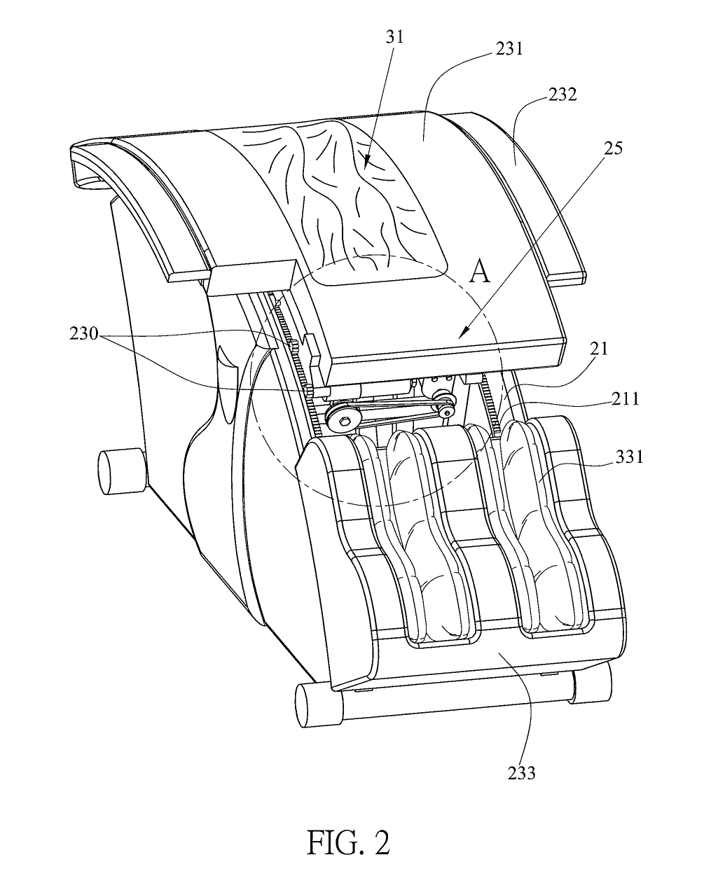

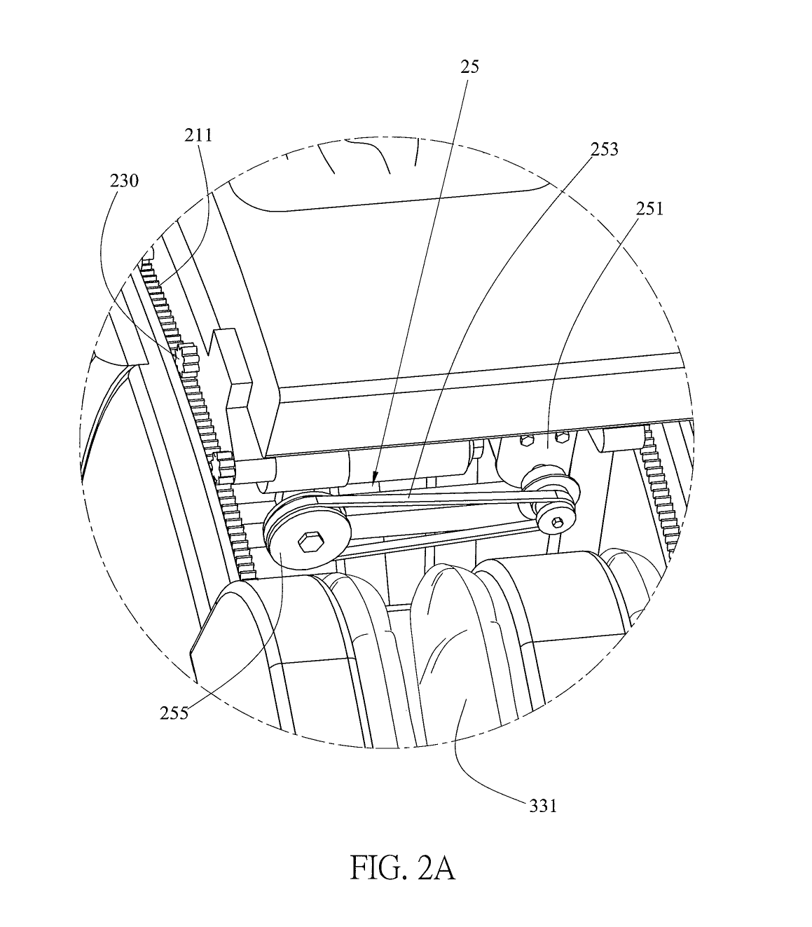

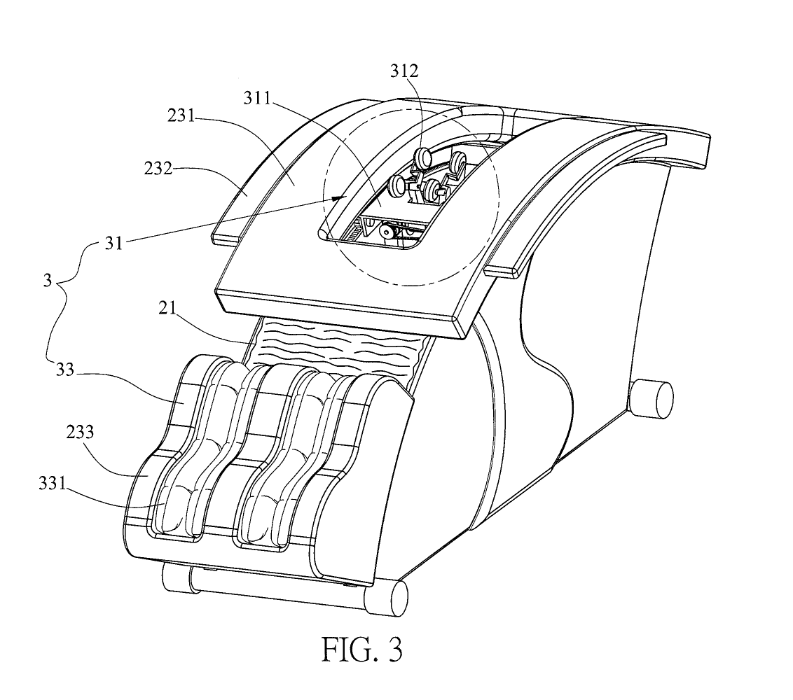

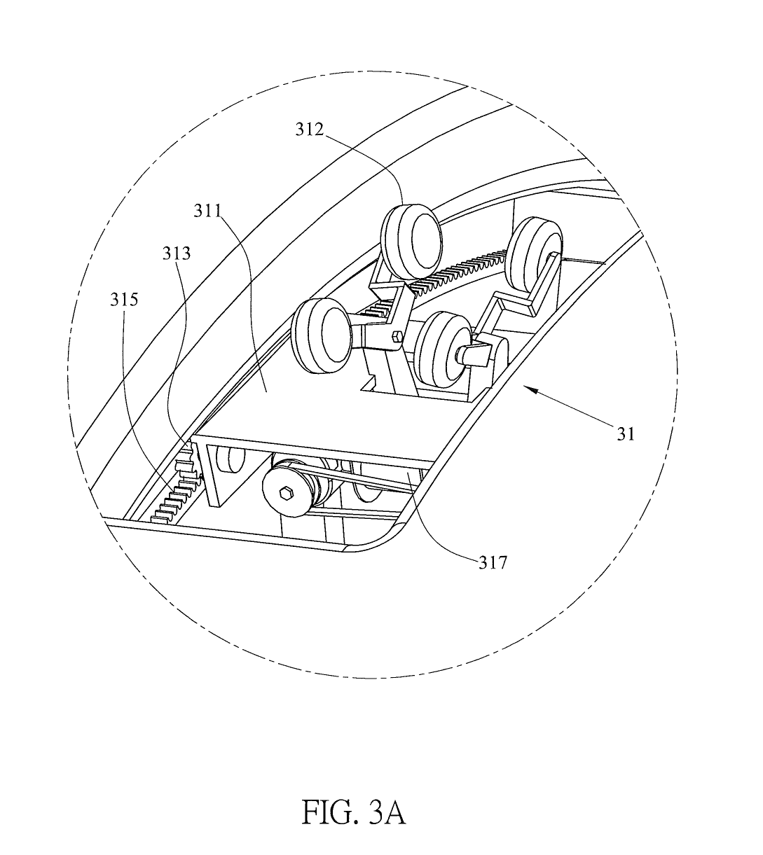

Referring to FIGS. 1 to 6, a massage bench in accordance with the invention comprises the following components as discussed in detail below.

A support 1 is provided with a backrest assembly 2 mounted on the support 1. The backrest assembly 2 comprises two parallel rails 21 secured to the support 1, each rail 21 having an arc top; and a sliding unit 23 including an arc sliding backrest 231 slidable about the rails 21, two armrests 232 for resting arms of a client and threadedly secured to both sides of the backrest 231, and a sliding foot rest 233 for resting feet of the client and being slidable about the rails 21.

The rail 21 comprises lengthwise teeth 211. A plurality of first gears 230 are provided on either side of the backrest 231 and in gear engagement with the teeth 211 so that the backrest 231 may move back and forth along the teeth 211 (i.e., the rails 21).

A drive assembly 25 comprises a first motor 251, an output shaft 255 operatively connected to the first gears 230, and a drive belt 253 placed across a pulley of a rotation shaft of the first motor 251 and a pulley of the output shaft 255. Thus, in response to activating the first motor 251 power of the first motor 251 can be transmitted to the output shaft 255 via the drive belt 253 to move the first gears 230 along the teeth 211. That is, both the backrest 231 and the foot rest 233 move along the rails 21.

A massage assembly 3 comprises a back massaging assembly 31 provided in the backrest 231 and including a moveable bracket 311, parallel lengthwise teeth 315 secured to the backrest 231, a plurality of second gears 313 provided on either side of the bracket 311 and in gear engagement with the teeth 315, a plurality of rollers 312 projecting out of the bracket 311 distal the support 1, and a second motor 317 for driving both the rollers 312 and the second gears 313. In response to activating the second motor 317 power of the second motor 317 can be transmitted to the second gears 313 to move the second gears 313 along the teeth 315 (i.e., moving the bracket 311 along the teeth 315) and to the rollers 312 to massage the back of a client lying on the backrest 231.

Additionally, a first vibration motor (not shown) can be provided in the back massaging assembly 31 for beating and vibrating the back of the client.

The massage assembly 3 further comprises a legs massaging assembly 33 provided on the foot rest 233. The legs massaging assembly 33 is operatively connected to the second motor 317 and comprises two pairs of air-inflatable cushions 331, each pair of air-inflatable cushions 331 adapted to tightly engage both sides of the part of the leg below the knee (i.e., the calf), and an air inflation device 333 for supplying air to the cushions 331 at one time to tighten and fasten the parts of the legs below the knees of a client (note that this can prevent the client from falling out of the backrest assembly 2 during a massage), and releasing air from the cushions 331 at an immediately next time so that a repeat of the above two steps can bring massage effects to the legs of the client.

Additionally, a second vibration motor (not shown) can be provided in the legs massaging assembly 33 for beating and vibrating the legs of the client.

A controller 40 is electrically connected to both the backrest assembly 2 and the massage assembly 3. A massage therapist or the client may operate the controller 40 to control the moving direction and/or moving speed of the sliding unit 23. Also, the massage therapist or the client may operate the controller 40 to control the strength and/or moving speed of the massage assembly 3. A receptacle 41 is provided on one side of the support 1 to hold the controller 40 when the massage bench is not in use.

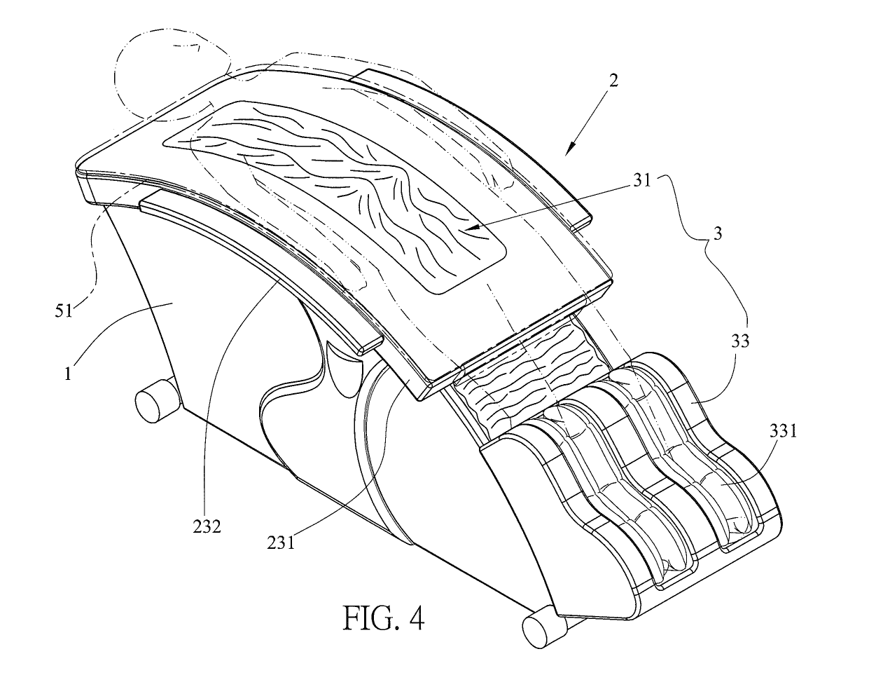

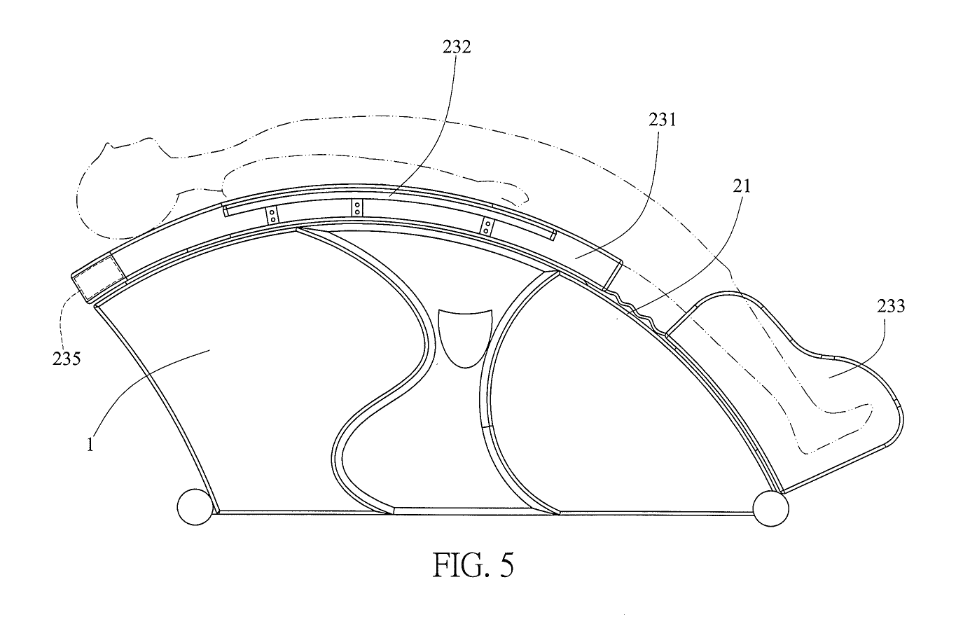

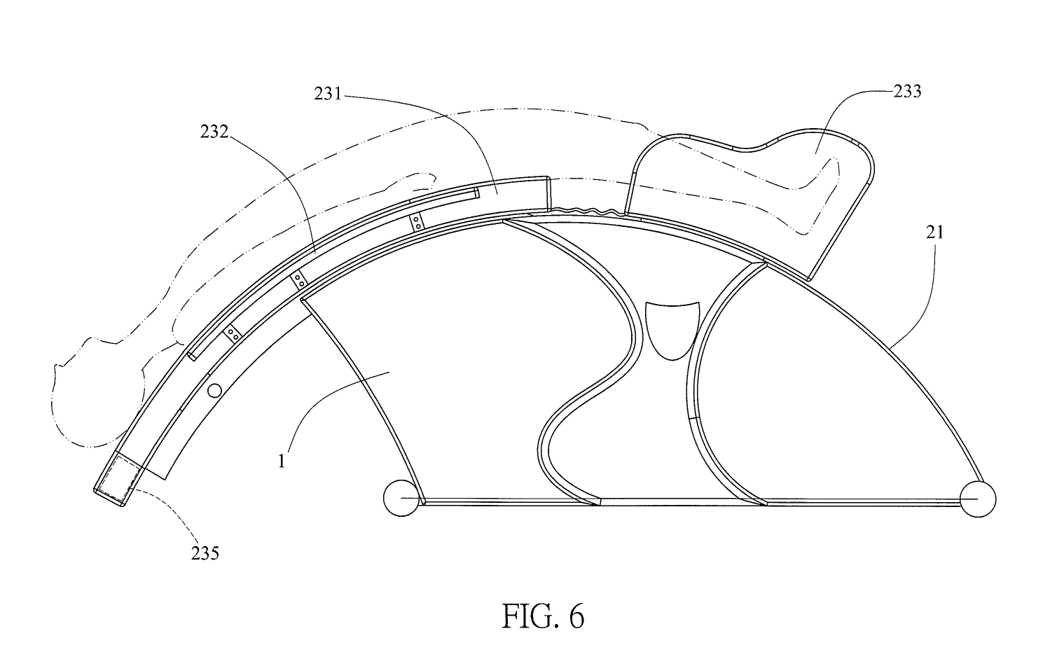

As shown in FIG. 4, a pad 51 is releasably provided on the backrest 231 by means of a zipper or hook and loop fabric fastener and additionally covers the back massaging assembly 31. As shown in FIGS. 5 and 6, a box 235 is provided on one end of the backrest 231 distal the legs massaging assembly 33 for storing the pad 51, a blanket, a pillow, or the like.

It is envisaged by the invention that a client lying on the backrest 231 with his/her legs rested on the legs massaging assembly 33 can be moved back and forth along an arc of the backrest assembly 2 so as to stretch the body and be slightly upside down during a massage (see FIGS. 5 and 6). Further, the sliding movement of the backrest 231 and the legs massaging assembly 33 can be temporarily stopped at any time during the massage if the client desires. Furthermore, the legs of the client are temporarily fastened by the legs massaging assembly 33 without being worried of falling. In addition, the back massaging assembly 31 can be activated to rub, beat, and knead the back of the client and/or the legs massaging assembly 31 can be activated to rub, beat, and knead the legs of the client.

While the invention has been described in terms of preferred embodiments, those skilled in the art will recognize that the invention can be practiced with modifications within the spirit and scope of the appended claims.

What is claimed is:

1. A massage bench comprising:
a support;
a backrest assembly slidably mounted on the support, the backrest assembly comprising two parallel arc rails secured to the support, each of the rails including lengthwise first teeth; and a sliding unit including an arc sliding backrest having a plurality of first gears on either side, the first gears being in gear engagement with the first teeth, and a sliding foot rest slidable about the first teeth;
a drive assembly comprising a first motor, an output shaft operatively connected to the first gears, and a drive belt placed across the first motor and the output shaft wherein in response to activating the first motor power of the first motor is transmitted to the output shaft to move the first gears along the first teeth so that both the backrest and the foot rest move along the rails; and
a massage assembly comprising a back massaging assembly disposed in the backrest and including a moveable bracket, parallel lengthwise second teeth secured to the backrest, a plurality of second gears disposed on either side of the bracket and being in gear engagement with the second teeth, a plurality of rollers projecting out of the bracket distal the support, and a second motor for driving both the rollers and the second gears wherein in response to activating the second motor power of the second motor is transmitted to the second gears to move the second gears along the second teeth and to the rollers; and a legs massaging assembly disposed on the foot rest, the legs massaging assembly being operatively connected to the second motor.

2. The massage bench of claim 1, further comprising a controller electrically connected to both the backrest assembly and the massage assembly, the controller being operable to control moving direction and/or moving speed of the sliding unit, and control strength and/or moving speed of the massage assembly.

3. The massage bench of claim 2, further comprising a receptacle disposed on one side of the support to hold the controller.

4. The massage bench of claim 1, further comprising a box disposed on one end of the backrest distal the legs massaging assembly.

5. The massage bench of claim 1, further comprising two armrests threadedly secured to both sides of the backrest respectively.

6. The massage bench of claim 1, the legs massaging assembly comprises two pairs of air-inflatable cushions, each pair of air-inflatable cushions being for clamping the calf, and an air inflation device for continually supplying air to the pairs of air-inflatable cushions.
